(19) United States
(12) Patent Application Publication
(10) Pub. No.: US 2025/0332693 A1
(43) Pub. Date: Oct. 30, 2025

(54) APPARATUS FOR ATTACHMENT TO SELF CENTERING VISE

(71) Applicant: Rogue Gator, LLC, Naples, FL (US)

(72) Inventor: Thomas Richard Rogan, Naples, FL (US)

(21) Appl. No.: 19/193,065

(22) Filed: Apr. 29, 2025

Related U.S. Application Data
(60) Provisional application No. 63/639,878, filed on Apr. 29, 2024.

(51) Int. Cl. B25B 1/24; B25B 1/02

(52) U.S. Cl. CPC B25B 1/2484; B25B 1/02

(57) ABSTRACT

A device for attachment to a self-centering vise includes a first adapter including one or more bores configured for attachment to a first movable platform within a base of the vise, and one or more holes, the first adapter having a dovetail protrusion on its top surface, configured for securely holding a first machinable jaw, a fastening device configured for attachment to the first adapter via the one or more holes, wherein the fastening device includes a dovetail protrusion configured for securely holding the first machinable jaw, a second adapter opposed to the first adapter for holding a second machinable jaw, and, wherein the first and second machinable jaws are configured for securely holding a workpiece for machining.

### CROSS-REFERENCE TO RELATED APPLICATIONS

This patent application claims priority to provisional patent application No. 63/639,878 filed Apr. 29, 2024. The subject matter of provisional patent application No. 63/639,878 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The claimed subject matter relates to the field of machining and, more particularly, for tools and apparatuses for holding workpieces during the machining process.

### BACKGROUND

The field of precision machining has long been integral to manufacturing processes across various industries, including aerospace, automotive, and medical device production. Central to these processes is the use of vises for securing workpieces during machining operations. The primary function of a vise in a machining setup is to hold a workpiece in a fixed position, allowing for precise material removal by machining tools. Traditional vises are designed with simplicity and durability in mind, featuring two opposing jaws that clamp down on the workpiece.

However, conventional vise designs pose several challenges when it comes to machining with high precision, particularly in applications requiring access to multiple sides of a workpiece. Standard vises often limit the machinability of a workpiece to three or four axes, restricting the ability to perform complex machining tasks that require multiple-axis manipulation. This limitation stems from the inability of traditional vise setups to securely hold a workpiece in a manner that provides unrestricted access to all its sides.

Additionally, the process of setting up a workpiece for multiple-axis machining can be time-consuming and labor-intensive, requiring specialized fixtures or multiple setups that increase production time and costs. The complexity of these setups can also introduce the potential for alignment errors, affecting the precision and quality of the machined parts.

Furthermore, the adaptability of vises to accommodate various shapes and sizes of workpieces is another concern. Standard vise jaws are typically designed for gripping regular geometric shapes, leading to difficulties in securely holding workpieces with irregular geometries or delicate features. This often necessitates the use of custom jaws or additional fixtures, further complicating the setup process and increasing the risk of damage to the workpiece during machining.

Therefore, a need exists for a universally adaptable solution that simplifies the setup for multiple-axis machining, reduces production time and costs, and maintains high precision and quality in a final machined product.

### BRIEF SUMMARY

In one embodiment, a device for attachment to a self-centering vise is disclosed. The device for attachment to a self-centering vise includes a first adapter configured for attachment to a first movable platform within a base of the vise, the first adapter including one or more holes on a side surface, the first adapter having a first dovetail protrusion on its top surface, configured for securely holding a first machinable jaw, a first fastening device configured for attachment to the first adapter via the one or more holes, wherein the first fastening device includes a dovetail protrusion configured for securely holding the first machinable jaw, a second adapter opposed to the first adapter, the second adapter configured for attachment to a second movable platform within the base of the vise and configured for securely holding a second machinable jaw opposed to the first machinable jaw, the second adapter comprising a first dovetail protrusion, and a second fastening device including a dovetail protrusion configured for securely holding the second machinable jaw, and wherein the first and second machinable jaws are configured for securely holding a workpiece for machining.

Additional aspects of the claimed subject matter will be set forth in part in the description which follows, and in part will be obvious from the description, or may be learned by practice of the claimed subject matter. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE SEVERAL VIEWS OF THE DRAWINGS

The accompanying drawings, which are incorporated in and constitute part of this specification, illustrate embodiments of the claimed subject matter and together with the description, serve to explain the principles of the claimed subject matter. The embodiments illustrated herein are presently preferred, it being understood, however, that the claimed subject matter is not limited to the precise arrangements and instrumentalities shown, wherein:

FIG. 1 is a front perspective partially exploded view of the claimed device for attachment to a self-centering vise, in accordance with a first embodiment.

FIG. 2 is a side perspective partially exploded view of the claimed device for attachment to a self-centering vise, in accordance with the first embodiment.

FIG. 3 is a side perspective view of the claimed device for attachment to a self-centering vise, wherein the device is utilized in the course of machining, in accordance with the first embodiment.

FIG. 4 is a side view of the claimed device for attachment to a self-centering vise, shown in an open position, in accordance with the first embodiment.

FIG. 5 is a side view of the claimed device for attachment to a self-centering vise, shown in a closed position, in accordance with the first embodiment.

FIG. 6 is a top perspective view of the claimed device for attachment to a self-centering vise, shown in an open position, in accordance with a second embodiment.

FIG. 7 is a top perspective partially exploded view of the claimed device for attachment to a self-centering vise, in accordance with the second embodiment.

FIG. 8 is a side perspective partially exploded view of the claimed device for attachment to a self-centering vise, in accordance with a third embodiment.

FIG. 9 is a top perspective partially exploded view of the claimed device for attachment to a self-centering vise, in accordance with the third embodiment.

FIG. 10 is another side perspective partially exploded view of the claimed device for attachment to a self-centering vise, in accordance with a third embodiment.

FIG. 11 is a front view of a securing element of the claimed device for attachment to a self-centering vise, in accordance with one embodiment.

FIG. 12 is a side view of a securing element of the claimed device for attachment to a self-centering vise, in accordance with one embodiment.

FIG. 13A is a perspective view of a securing element of the claimed device for attachment to a self-centering vise, in accordance with one embodiment.

FIG. 13B is a front view of a securing element of the claimed device for attachment to a self-centering vise, in accordance with one embodiment.

FIG. 13C is a side view of a securing element of the claimed device for attachment to a self-centering vise, in accordance with one embodiment.

FIG. 13D is a perspective view of a securing element of the claimed device for attachment to a self-centering vise, in accordance with one embodiment.

FIG. 14 is a top perspective view of a fastening device of the claimed device for attachment to a self-centering vise, in accordance with one embodiment.

FIG. 15 is a front perspective view of a fastening device of the claimed device for attachment to a self-centering vise, in accordance with one embodiment.

FIG. 16 is a side view of a fastening device of the claimed device for attachment to a self-centering vise, in accordance with one embodiment.

FIG. 17 is a top perspective view of the adapter of the claimed device for attachment to a self-centering vise, in accordance with one embodiment.

FIG. 18 is a rear perspective view of the adapter of the claimed device for attachment to a self-centering vise, in accordance with one embodiment.

FIG. 19 is a bottom perspective view of the adapter of the claimed device for attachment to a self-centering vise, in accordance with one embodiment.

FIG. 20 is a side view of the adapter of the claimed device for attachment to a self-centering vise, in accordance with one embodiment.

FIG. 21 is a top perspective view of a machinable jaw of the claimed device for attachment to a self-centering vise, in accordance with one embodiment.

FIG. 22 is a side view of a machinable jaw of the claimed device for attachment to a self-centering vise, in accordance with one embodiment.

FIG. 23 is a bottom perspective view of a machinable jaw of the claimed device for attachment to a self-centering vise, in accordance with one embodiment.

FIG. 24 is a side view of the claimed device for attachment to a self-centering vise, in an assembled form, in accordance with the third embodiment.

FIG. 25 is a top perspective view of an alternative adapter of the claimed device for attachment to a self-centering vise, in accordance with one embodiment.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed device introduced for attachment to a self-centering vise embodies an advance in precision machining in its utility in multiple-axis machining operations. The claimed device improves workpiece accessibility, enabling secure and versatile machining without the need for complex setups or repositioning, a common limitation with traditional vise designs. The dual adapter configuration, featuring dovetail protrusions for securely holding machinable jaws, facilitates uninterrupted multiple-axis machining, enhancing both the efficiency and accuracy of the machining process.

The claimed device reduces setup time and allows for quick and secure attachment and adjustment of the workpiece, thereby accelerating the production cycle and ensuring consistent quality and precision in machining. Moreover, the stability and precision of the workpiece during machining is improved. The claimed device provides a robust grip that minimizes vibrations and unwanted movements, directly translating into higher quality finishes and accurate dimensions.

The claimed device is further adaptable to various workpiece geometries. Traditional vise jaws often struggle with irregular shapes or delicate materials, but the configurable nature of this device's machinable jaws allows for custom adjustments to securely hold and precisely machine a wide array of workpiece designs. This adaptability broadens the range of applications, making the vise suitable for varied machining projects.

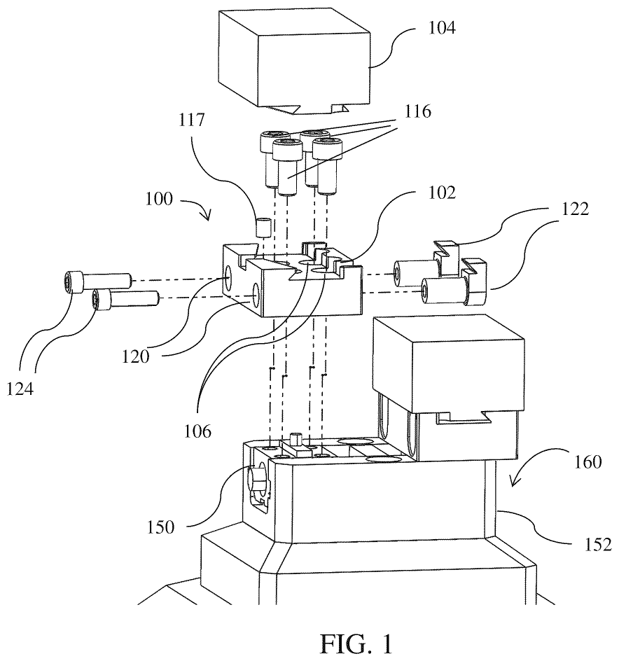

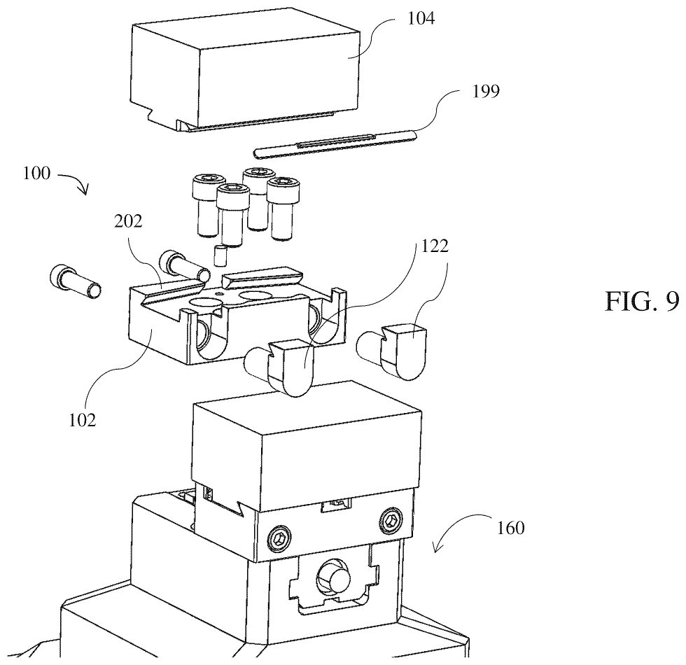

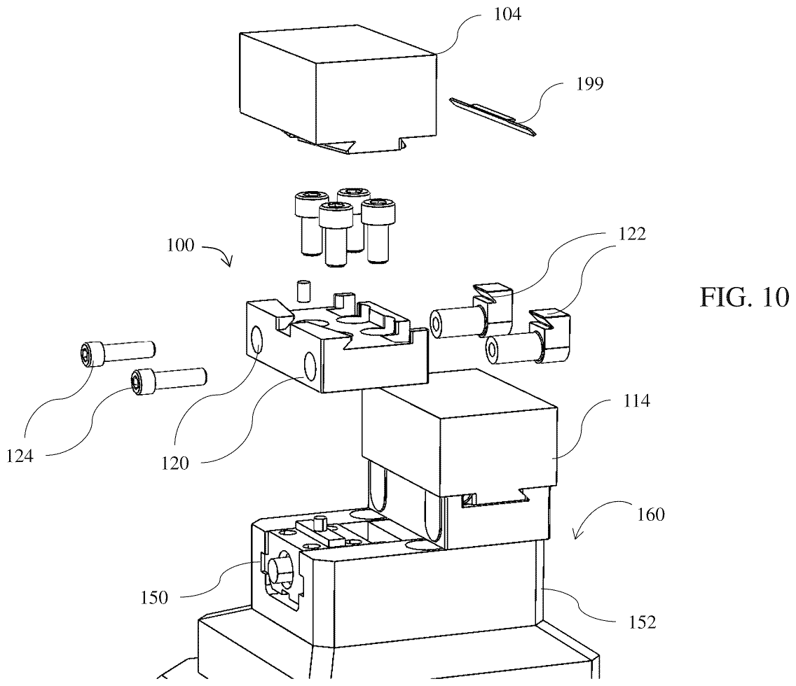

Referring now to the drawing figures in which like reference designators refer to like elements, the claimed device will now be described with reference to FIGS. 1-25.

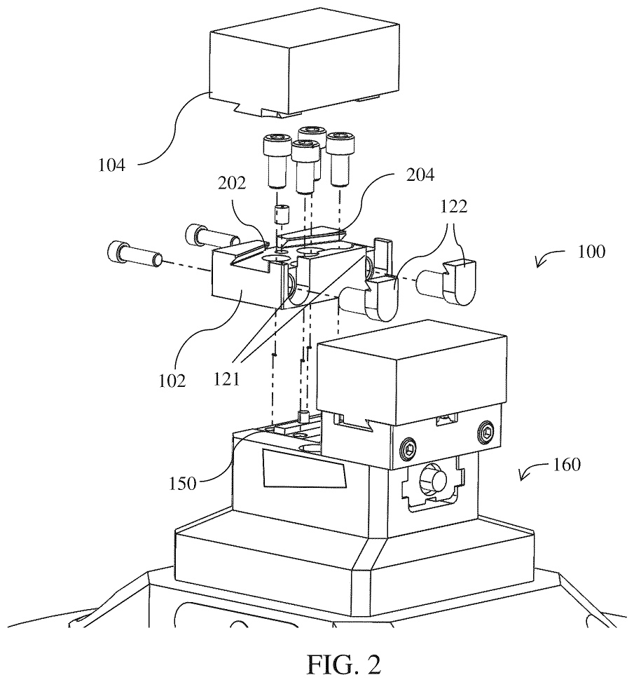

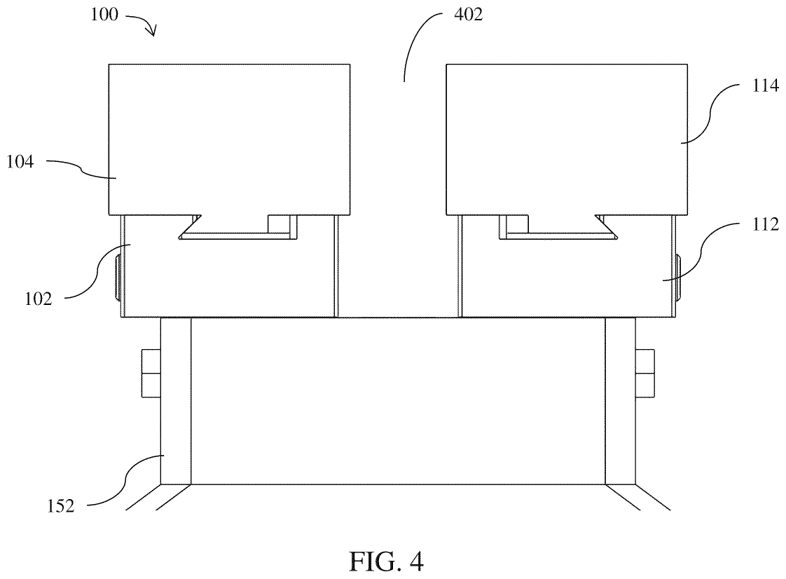

FIG. 1 presents a front perspective partially exploded view of the device 100 for attachment to a self-centering vise 160, showcasing the individual components and their assembly order. FIG. 1 illustrates the first adapter 102, which includes multiple bores 106 (and corresponding bolts 116) designed for securing the first adapter to the first movable platform 150 within the main vise assembly 152 of the vise 160. FIG. 2 shows the dovetail protrusions 202, 204 on the top surface of the first adapter 102, intended for the secure holding of a first machinable jaw 104. The corresponding fastening device(s) 122 can be attached to the first adapter 102 using one or more bolts 124 through the designated holes 120 in the adapter 102. The fastening device(s) 122 each have their own dovetail protrusion for additional grip on the first machinable jaw 104. FIG. 4 shows the second adapter 112, mirroring the first adapter 102 in its attachment to the opposing movable platform and its ability to secure a second machinable jaw 114 as well. Each adapter 102, 112 and their respective fastening devices are designed to provide a sturdy framework for holding the workpiece 302 securely for machining. FIG. 1 further shows a locating pin 117 which is used to precisely locate the machinable jaw.

FIG. 1 shows four bores 106 located on a top (horizontal) surface of the adapter 102 and extending directly downwards through the adapter, and four corresponding bolts 116 that extends through said bores and attach to the underlying movable platform 150. FIG. 1 also shows two holes 120 in a side (vertical) surface of the adapter and FIG. 2 shows two holes 121 in a side (vertical) surface of the adapter that is opposite the side with the two holes 120. Two corresponding bolts 124 extend through the two holes 120 and two fastening device 122 extend through the two holes 121. The fastening devices 122 include threaded holes that are configured to mate with the bolts 124 when said bolts and fastening devices are inserted into the adapter. Note that the inside vertical surface of the adapter where holes 121 are located have cutouts shaped like the head of the fastening device (i.e., a semicircular shape with a flat side) such that the fastening devices fit snugly into the adapter.

FIG. 2, a side perspective partially exploded view of the device 100 reveals the arrangement and interaction of the adapters 102, 112 and fastening devices from a different angle. FIG. 2 emphasizes the depth and shape of the dovetail protrusions 202, 204 on the adapter 102 and the dovetail protrusions on the fastening devices 122, highlighting how these elements are engineered to match the corresponding machinable jaws. The dovetail protrusions 202, 204 on the adapter 102 and the dovetail protrusions on the fastening devices 122 ensure a snug and secure fit with the underside of the machinable jaw 104, preventing movement or misalignment during machining processes. The perspective of FIG. 1 and FIG. 2 also allows for a clear view of the underside of the machinable jaw 104, which includes dovetail protrusions that are designed to mate with the dovetail protrusions 202, 204 on the adapter 102 and the dovetail protrusions on the fastening devices 122.

The dovetail protrusions 202, 204 on the top surface of the first adapter 102 may be arranged in a V-shaped configuration. Likewise, the underside of the machinable jaw 104 may include dovetail protrusion in a V-shaped configuration, wherein said dovetail protrusions are configured for mating with the dovetail protrusion 202, 204 on the top surface of the first adapter 102. Later figures show the V-shaped configuration of the dovetail protrusions in the machinable jaws 104, 114 of the device 100.

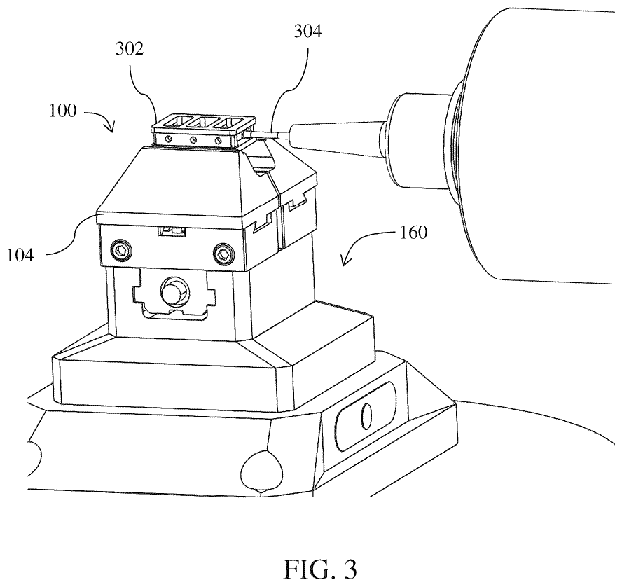

FIG. 3 offers a side perspective view of the device 100 as it is utilized in the course of machining, attached to a self-centering vise 160 and holding a workpiece 302. FIG. 3 showcases the device in action, with the first and second machinable jaws 104, 114 clamping down on a workpiece 302 and a machine bit, endmill or cylindrical cutting tool 304 removing material from the workpiece. FIG. 3 illustrates how the dovetail protrusions of the fastening devices 122 and adapters 102, 112 interact with the machinable jaws 104, 114 to provide a secure grip. The arrangement shown in FIG. 3 ensures that the workpiece 302 is held firmly in place, allowing for precision machining from multiple angles without the need for repositioning. FIG. 3 demonstrates how the device 100 may be used to machine a workpiece 302 in a 2-axis, 3-axis, 4-axis and/or 5-axis paradigm. FIG. 3 further shows how each of the machinable jaws 104, 114 have been machined, formed, or adapted to hold the workpiece 302 in such a way that it is accessible to the cutting tool 304 from multiple axes.

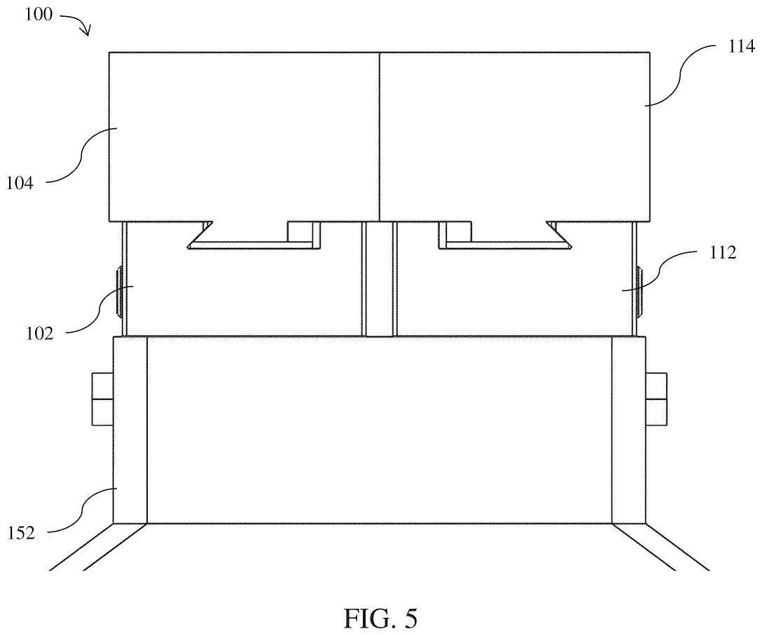

FIG. 4 presents a side view of the device 100 in an open position, attached to the vise 160 but without a workpiece. This view highlights the components' readiness for workpiece insertion, with the machinable jaws apart, hence the gap 402 between the machinable jaws. The positioning of the first and second adapters 102, 112, along with their fastening devices, is clearly visible, emphasizing the ease with which a workpiece 302 can be inserted and secured. FIG. 4 further shows how the underside of the machinable jaws 104, 114 includes dovetail protrusions that are designed to mate with the dovetail protrusions 202, 204 on the adapters 102, 112 and the dovetail protrusions on the fastening devices 122. The configuration of the dovetail protrusions in the adapters and the machinable jaws work to self-center the machinable jaws and, by extension, the workpiece 302 along the central longitudinal axis of the vise 160, which runs perpendicular to the plane at which the machinable jaws meet (as shown in FIG. 5).

FIG. 5 shows a side view of the device in a closed position, where the machinable jaws are brought together to clamp a workpiece. FIG. 5 illustrates the culmination of the components' interactions, where the precise engineering of the dovetail protrusions, adapters, and fastening devices ensures a secure and stable hold on the machinable jaws to clamp a workpiece. The closed position demonstrates the device's effective adaptation to the contours and requirements of the workpiece, highlighting its capability to accommodate a variety of shapes and sizes, ensuring precise and secure machining.

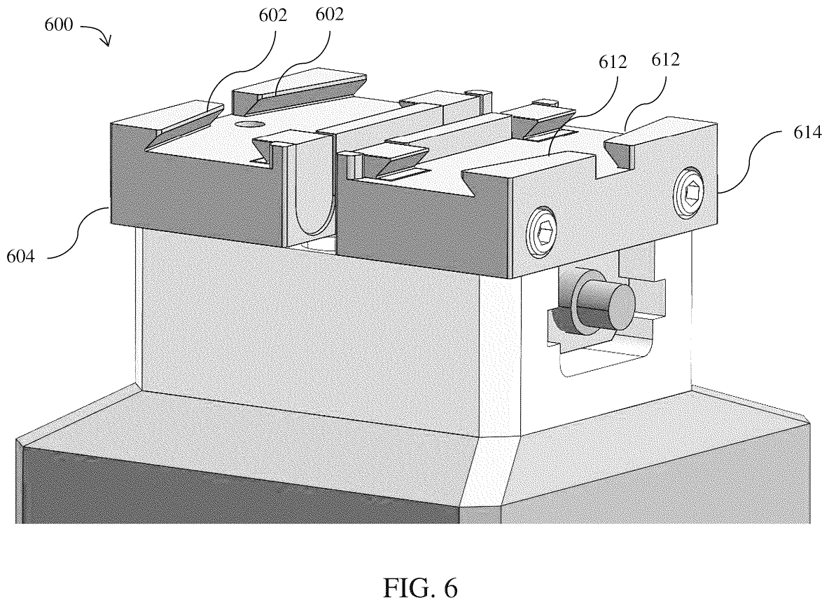

FIG. 6 is a top perspective view of the claimed device 600 for attachment to a self-centering vise, shown in an open position, in accordance with a different embodiment wherein each adapter 604, 614 is combined with the underlying movable platform as a single, integrated piece. In this embodiment, there are no multiple bores 106 (and corresponding bolts 116) necessary for securing the adapter to the underlying movable platform. FIG. 6 shows the V-shaped configuration of the dovetail protrusion pairs 602 and 612 in the respective adapters 604, 614 the device 600.

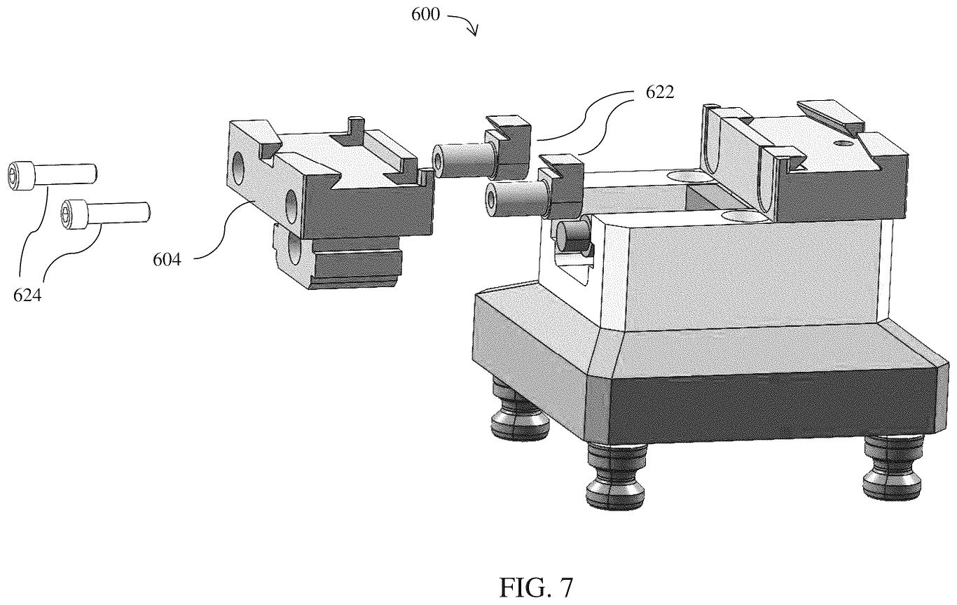

FIG. 7 is a top perspective partially exploded view of the claimed device 600 for attachment to a self-centering vise, in accordance with another embodiment. FIG. 7 shows that the corresponding fastening device(s) 622 can be attached to the first adapter 604 using one or more bolts 624 through the designated holes in the adapter 604. FIG. 7 shows that the adapter 604 is combined with the underlying movable platform as a single, integrated piece.

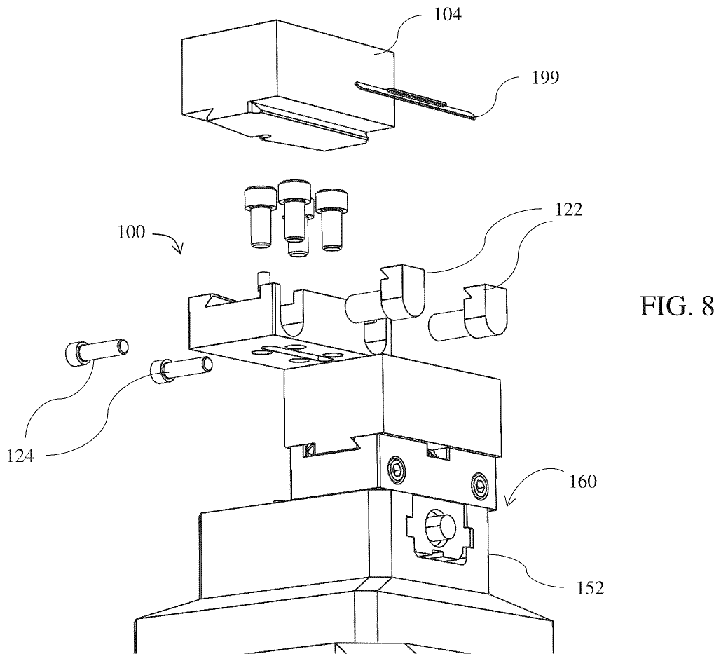

FIGS. 8-10 show perspective partially exploded views of the claimed device 100 for attachment to a self-centering vise, in accordance with a third embodiment. The views of FIGS. 8-10 are almost identical to FIGS. 1-2 with the exception of the addition of a clamp load distributor 199 that is placed in between the adapter and the machinable jaw. When using machinable jaws made from materials significantly softer than device 100 to minimize deflection and prevent deformation, the clamp load distributor 199 may be used. The clamp load distributor 199 may be composed of hardened steel, which assists in keeping the softer materials (i.e., dovetails) from deforming when maximum clamping pressure is required. The clamp load distributor 199 operates similar to a snowshoe between the fastening device's dovetail protrusion and the dovetail on the machinable jaw.

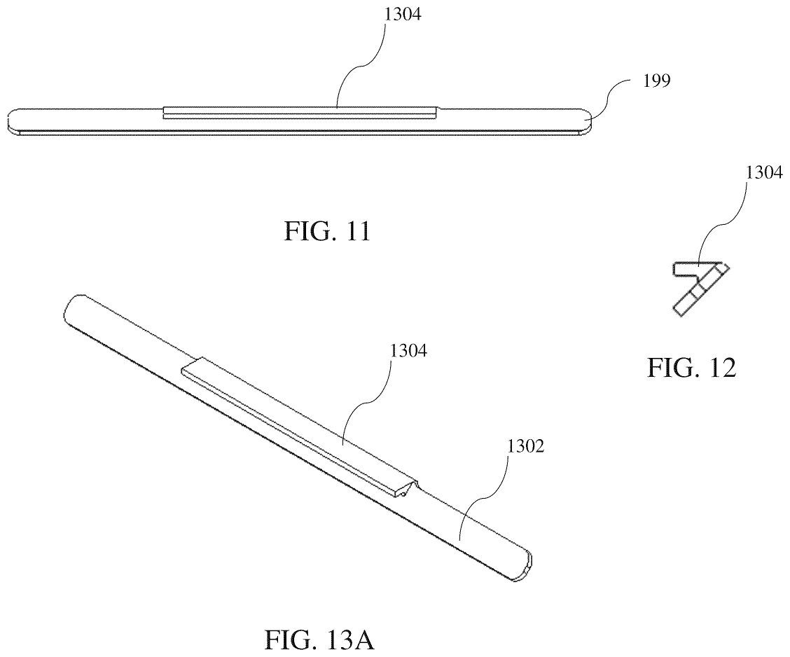

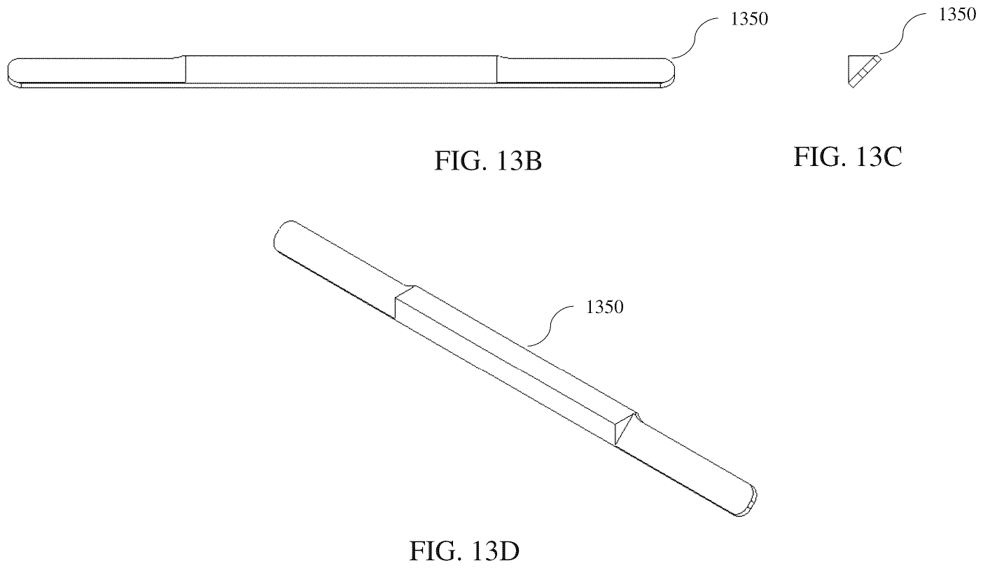

FIGS. 11-13A show different views of the clamp load distributor 199 of the claimed device 100 for attachment to a self-centering vise, in accordance with one embodiment. The clamp load distributor 199 comprises a main body 1302 comprising an elongated element having rounded ends, as well as a lifted element 1304 that originates from, and extends from one side of the main body. The lifted element 1304 may be, though is not required to be, centered on the main body and may not extend the entire length of the main body, but rather only a portion thereof. Seen from the side in FIG. 12, it is shown that there is an approximate 45 degree angle between the lifted element and the main body, though that angle could range from 30-65 degrees. FIGS. 13B-13D show different views of another embodiment of a clamp load distributor 1350 of the claimed device 100 for attachment to a self-centering vise. The clamp load distributor 1350 comprises a main body with an elongated element having rounded ends, wherein at least a portion of the main body has a triangular cross section. The triangular cross section is centered on the main body and does not extend the entire length of the main body, but rather only a portion thereof. Seen from the side in FIG. 13C, the triangular cross section is shown.

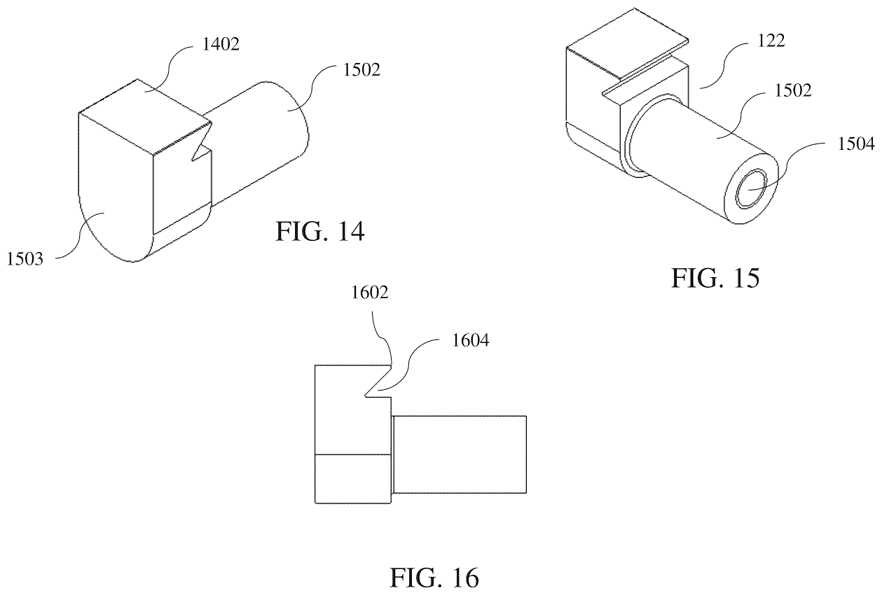

FIGS. 14-16 show various views of a fastening device 122 of the claimed device 100 for attachment to a self-centering vise, in accordance with one embodiment. The fastening device 122 comprises a cylindrical element 1502 configured to fit within the hole 121 and having a threaded bore 1504 extending through said cylindrical element, said bore configured to mate with bolt 124. The fastening device 122 further comprises a head 1402 with an outward flat (vertical) surface 1503 shaped like a semicircle with a flat end, so as to fit securely within the cutout at the outward end of the hole 121 in the adapter. The head includes a dovetail protrusion 1602 on the inward facing surface of the head, the protrusion shaped like a protruding wedge or triangle and defining a similar (wedge or triangle shaped) depression 1604 configured to mate with the dovetail protrusion of the machinable jaw 104.

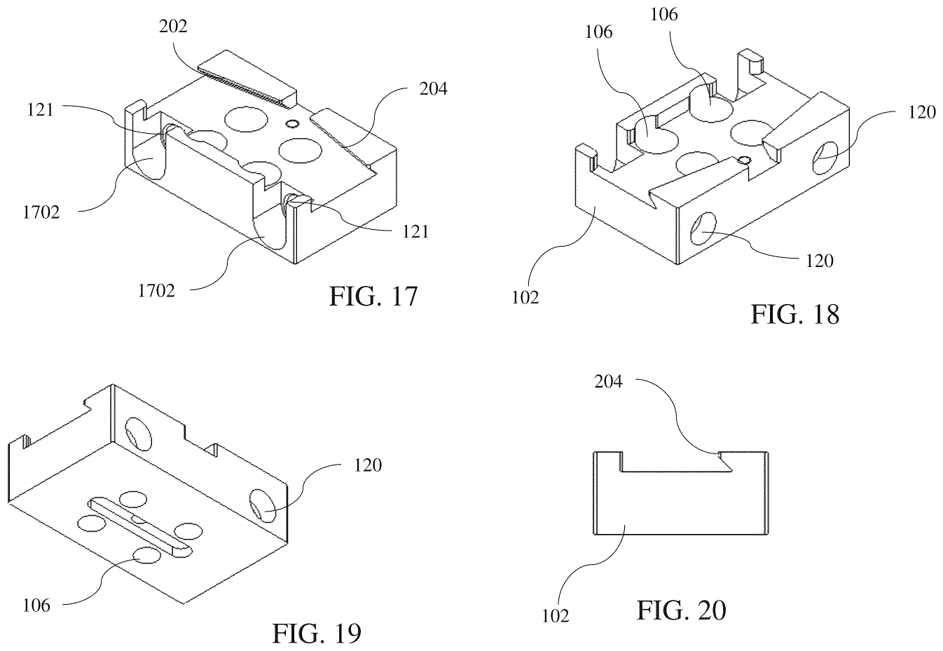

FIGS. 17-20 show different views of the adapter 102 of the claimed device 102 for attachment to a self-centering vise, in accordance with one embodiment. Four bores 106 are located on a top (horizontal) surface of the adapter 102 and extending directly downwards through the adapter. Two holes 120 in a side (vertical) surface of the adapter and two holes 121 in a side (vertical) surface of the adapter that is opposite the side with the two holes 120. The vertical surface of the adapter where holes 121 are located have cutouts 1702 shaped like the surface 1503 of head 1402 of the fastening device (i.e., a semicircular shape with a flat side) such that the fastening devices fit snugly into the adapter.

The adapter 102 includes a pair of dovetail protrusions 202-204 on an inward facing surface of the head, the protrusion shaped like a protruding wedge or triangle and defining a similar (wedge or triangle shaped) depression configured to mate with the dovetail protrusion of the machinable jaw 104. The dovetail protrusions 202, 204 on the top surface of the first adapter 102 are arranged in a V-shaped configuration. Likewise, the underside of the machinable jaw 104 may include dovetail protrusion in a V-shaped configuration, wherein said dovetail protrusions are configured for mating with the dovetail protrusion 202, 204 on the top surface of the first adapter 102.

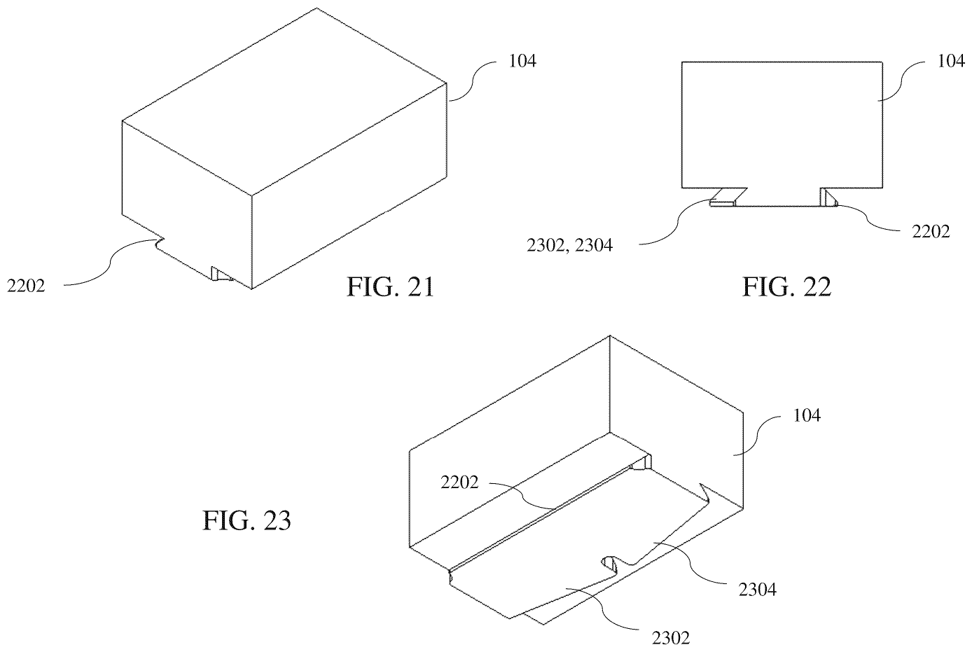

FIGS. 21-23 show different views of a machinable jaw 104 of the claimed device 100 for attachment to a self-centering vise, in accordance with one embodiment. The underside of the machinable jaw 104 includes a pair 2302, 2304 of dovetail protrusions in a V-shaped configuration and a dovetail protrusion 2202 facing in the opposite direction from the pair 2302, 2304 of dovetail protrusions. These back-to-back protrusions provide opposing sides on which the adapters can clamp onto the machinable jaw 104 with opposing forces.

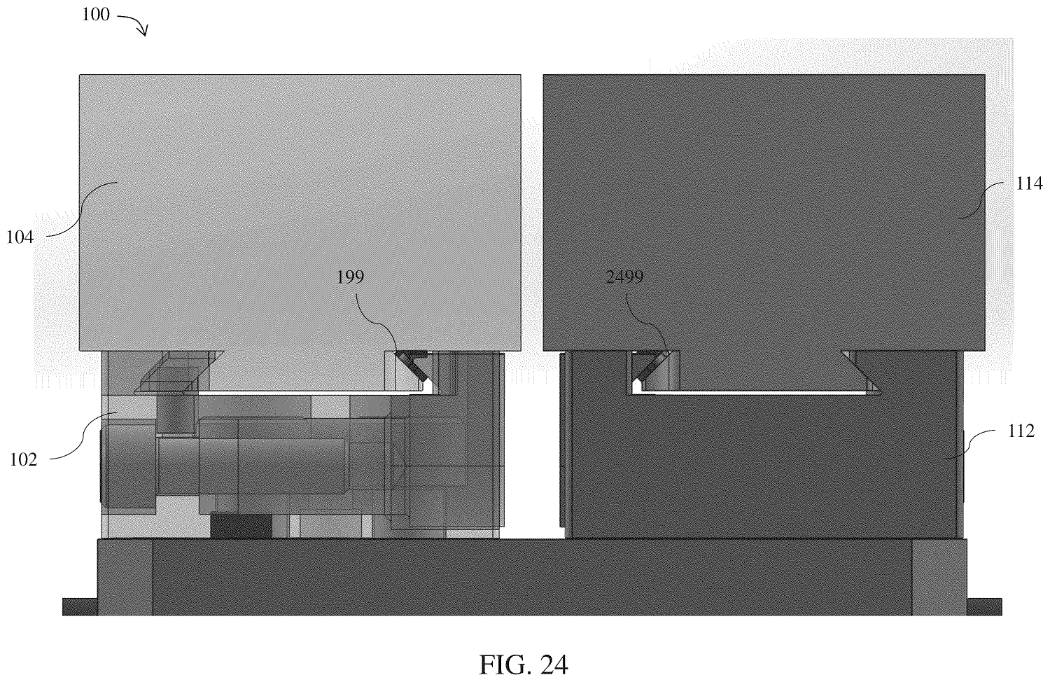

FIG. 24 is a side view of the claimed device 100 for attachment to a self-centering vise, in an assembled form, in accordance with the third embodiment. FIG. 24 shows that adapter 102 has successfully clamped machinable jaw 104 and adapter 112 has successfully clamped machinable jaw 114. A clamp load distributor 199 is placed in between the adapter 102 and the machinable jaw 104. The clamp load distributor 199 is located between the dovetail protrusion 1602 of the fastening device 122 and the dovetail protrusion 2202 on the machinable jaw 104. Also, a clamp load distributor 2499 is placed in between the adapter 112 and the machinable jaw 114. The clamp load distributor 2499 is located between the dovetail protrusion of the fastening device and the dovetail protrusion on the machinable jaw 114.

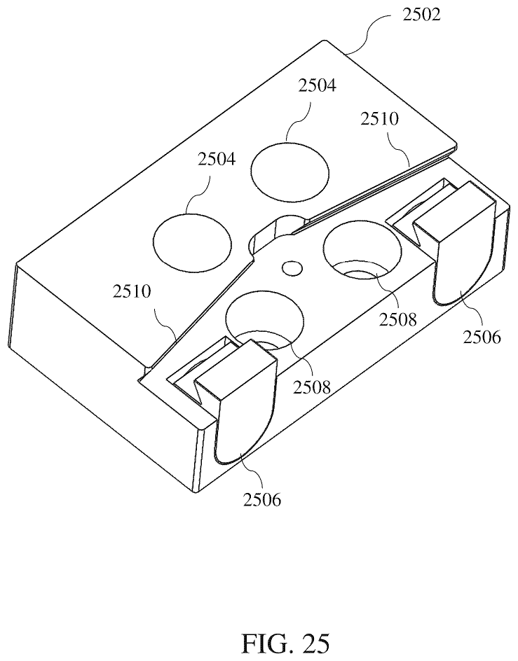

FIG. 25 is a top perspective view of an alternative adapter 2502 of the claimed device for attachment to a self-centering vise, in accordance with one embodiment. Two bores 2504 are located on an upper top (horizontal) surface of the adapter 2502 and extending directly downwards through the adapter. Two bores 2508 are located on a lower top (horizontal) surface of the adapter 2502 and extending directly downwards through the adapter. Two holes are located in a side (vertical) surface of the adapter wherein the holes have cutouts shaped like the surface of the head of the fastening devices 2506 (i.e., a semicircular shape with a flat side) such that the fastening devices fit snugly into the adapter. The adapter 2502 includes a pair of dovetail protrusions 2510 on an inward facing surface of the head, the protrusion shaped like a protruding wedge or triangle and defining a similar (wedge or triangle shaped) depression configured to mate with the dovetail protrusion of the machinable jaw 104. The dovetail protrusions 2510 on the top surface of the adapter 2502 are arranged in a V-shaped configuration.

In one embodiment, the claimed device, or any of its components, may be composed of 17-4PH stainless steel which may be heat treated to a final condition named H900, which exhibits strength, hardness, and high corrosion resistance. In another embodiment, the claimed device, or any of its components, may be composed of 17-7PH stainless steel and/or 15-5PH stainless steel which may be heat treated. In another embodiment, the claimed device, or any of its components, may be composed of copper alloys, aluminum alloys, steel, alloy steels, stainless steels, tool steels, and other hardenable alloy steels, such as 4140 and/or 4130.

While certain embodiments have been described, other embodiments may exist. The claimed embodiments may be used with substances used in other fields such as industrial, manufacturing, automotive, marine, medical or the like. Further, the disclosed components may be modified in any manner, including by reordering components and/or inserting or deleting components, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A device for attachment to a self-centering vise, the device comprising:
a) a first adapter configured for attachment to a first movable platform within a base of the vise, the first adapter including one or more holes on a side surface;
b) the first adapter having a first dovetail protrusion on its top surface, configured for securely holding a first machinable jaw;
c) a first fastening device configured for attachment to the first adapter via the one or more holes, wherein the first fastening device includes a dovetail protrusion configured for securely holding the first machinable jaw;
d) a second adapter opposed to the first adapter, the second adapter configured for attachment to a second movable platform within the base of the vise and configured for securely holding a second machinable jaw opposed to the first machinable jaw, the second adapter comprising a first dovetail protrusion, and a second fastening device including a dovetail protrusion configured for securely holding the second machinable jaw; and
e) wherein the first and second machinable jaws are configured for securely holding a workpiece for machining.

2. The device of claim 1, wherein the one or more bores comprises at least four bores.

3. The device of claim 2, wherein the one or more holes comprises two holes.

4. The device of claim 3, wherein the top surface of the first adapter comprises a second dovetail protrusion.

5. The device of claim 4, wherein the first dovetail protrusion and the second dovetail protrusion on the top surface of the first adapter are arranged in a V-shaped configuration.

6. The device of claim 5, wherein the first fastening device includes a cylindrical element configured for insertion into the first adapter using a bolt via the one or more holes.

7. The device of claim 6, further wherein the bolt extends through a longitudinal axis of the first fastening device.

8. The device of claim 7, wherein the first machinable jaw includes a first dovetail protrusion and a second dovetail protrusion configured for mating with the first dovetail protrusion and the second dovetail protrusion on the top surface of the first adapter.

9. The device of claim 8, wherein the first dovetail protrusion and the second dovetail protrusion of the first machinable jaw are arranged in a V-shaped configuration.

10. The device of claim 9, wherein the second machinable jaw includes a first dovetail protrusion and a second dovetail protrusion identical to the first machinable jaw.

11. A device for attachment to a self-centering vise, the device comprising:
a) a first adapter having a first movable platform within a base of the vise, the first adapter including one or more holes on a side surface;
b) the first adapter having a first dovetail protrusion on its top surface, configured for securely holding a first machinable jaw;
c) a first fastening device configured for attachment to the first adapter via the one or more holes, wherein the first fastening device includes a dovetail protrusion configured for securely holding the first machinable jaw;
d) a second adapter opposed to the first adapter, the second adapter having a second movable platform within the base of the vise and configured for securely holding a second machinable jaw opposed to the first machinable jaw, the second adapter comprising a first dovetail protrusion, and a second fastening device including a dovetail protrusion configured for securely holding the second machinable jaw; and
e) wherein the first and second machinable jaws are configured for securely holding a workpiece for machining.

12. The device of claim 11, wherein the one or more bores comprises at least four bores.

13. The device of claim 12, wherein the one or more holes comprises two holes.

14. The device of claim 13, wherein the top surface of the first adapter comprises a second dovetail protrusion.

15. The device of claim 14, wherein the first dovetail protrusion and the second dovetail protrusion on the top surface of the first adapter are arranged in a V-shaped configuration.

16. The device of claim 15, wherein the first fastening device includes a cylindrical element configured for insertion into the first adapter using a bolt via the one or more holes.

17. The device of claim 16, further wherein the bolt extends through a longitudinal axis of the first fastening device.

18. The device of claim 17, wherein the first machinable jaw includes a first dovetail protrusion and a second dovetail protrusion configured for mating with the first dovetail protrusion and the second dovetail protrusion on the top surface of the first adapter.

19. The device of claim 18, wherein the first dovetail protrusion and the second dovetail protrusion of the first machinable jaw are arranged in a V-shaped configuration.

20. The device of claim 19, further comprising a clamp load distributor having an elongated form, the clamp load distributor configured for placement between the first adapter and the first machinable jaw.
